(19) United States
(12) Patent Application Publication
(10) Pub. No.: US 2015/0062106 A1
(43) Pub. Date: Mar. 5, 2015

(54) DISPLAY DEVICE

(71) Applicant: Samsung Display Co., Ltd., Yongin-City (KR)

(72) Inventor: Jun-Ho HWANG, Asan-si (KR)

(21) Appl. No.: 14/339,964

(22) Filed: Jul. 24, 2014

(30) Foreign Application Priority Data
Aug. 28, 2013 (KR) 10-2013-0102488

(51) Int. Cl. G09G 3/36

(52) U.S. Cl. CPC G09G 3/3688; G09G 3/3603; G09G 2310/0291; G09G 2300/0408; G09G 2300/088; G09G 2320/041; G09G 2310/027
USPC 345/212; 345/98

(57) ABSTRACT

A display device includes: a display panel including a gate line, a data line and a pixel connected to the gate line and the data line; a data driver connected to the data line; a gate driver connected to the gate line; a direct current-to-direct current (“DC-DC”) unit which transfers a gate-on voltage or a gate-off voltage to the gate driver; a signal controller which controls the data driver, the gate driver and the DC-DC unit; and a sensing unit, in which the DC-DC unit generates a power voltage based on a control signal of the signal controller, and the sensing unit includes a measuring unit which senses a sensing signal based on a power voltage signal applied to the data driver, and a reset signal generator which generates a reset signal based on the sensing signal.

This application claims priority to Korean Patent Application No. 10-2013-0102488, filed on Aug. 28, 2013, and all the benefits accruing therefrom under 35 U.S.C. §119, the contents of which are incorporated by reference herein in its entirety.

### BACKGROUND

(a) Field

Exemplary embodiments of the invention relate to a display device.

(b) Description of the Related Art

Display devices are widely used for computer monitors, televisions, mobile phones, and the like. The display devices include a cathode ray tube display device, a liquid crystal display, a plasma display, and the like.

An electronic device such as a display device includes a plurality of electronic components such as a transistor, a diode, a resistor and an integrated circuit (“IC”) chip. Generally, the electronic components are mounted on various circuit boards such as a printed circuit board. The printed circuit board is formed by printing a circuit pattern on an insulation substrate with a conductive material such as copper. The circuit pattern includes a connection pattern for connection with an external electronic component.

In such electronic components, e.g., the IC chip, heat generated therein may be increased as a data load of the display device is increased.

### SUMMARY

Exemplary embodiments of the invention provide a display device in which overheating of a driver driving chip is effectively prevented based on a power voltage.

An exemplary embodiment of the invention provides a display device including: a display panel including a gate line, a data line and a pixel connected to the gate line and the data line; a data driver connected to the data line; a gate driver connected to the gate line; a current-to-direct current (“DC-DC”) unit which transfers a gate-on voltage or a gate-off voltage to the gate driver; a signal controller which controls the data driver, the gate driver and the DC-DC unit; and a sensing unit, in which the DC-DC unit generates a power voltage based on a control signal of the signal controller, and the sensing unit includes a measuring unit which senses a sensing signal based on the power voltage signal applied to the data driver, and a reset signal generator which generates a reset signal based on the sensing signal.

In an exemplary embodiment, the sensing unit may include a first resistor, and the sensing signal may have a value corresponding to a voltage drop value in the first resistor based on the power voltage.

In an exemplary embodiment, when the value of the sensing signal is equal to or less than a predetermined value, the reset signal generator may output a reset signal in a high level based on a reset voltage applied thereto.

In an exemplary embodiment, the reset signal generator may include a transistor.

In an exemplary embodiment, when the value of the sensing signal is greater than the predetermined value, the reset signal generator may output the reset signal in a low level by the transistor which is turned on by the sensing signal and thereby connects the reset voltage to a ground.

In an exemplary embodiment, the predetermined value may be about 0.01 volt (V).

In an exemplary embodiment, the sensing unit may further include an amplifier which amplifies the sensing signal.

In an exemplary embodiment, the sensing unit may further include a resistance unit which distributes a current flowing in the resistor of the sensing unit to flow in the amplifier.

In an exemplary embodiment, the display device may further include a diode unit which receives an output signal from the amplifier and applies a signal, which turns on the transistor when the value of the sensing signal is greater than about 0.01 V, to the transistor.

In an exemplary embodiment, the signal controller may stop the operation when the signal controller receives the reset signal in the low level.

In an exemplary embodiment, the signal controller may control the DC-DC unit to control the generation of the power voltage when the signal controller receives the reset signal in the low level.

In an exemplary embodiment, the transistor of the reset signal generator the may be an NPN transistor.

In an exemplary embodiment, the diode unit may include two diodes connected to each other in series.

In an exemplary embodiment, the measuring unit may be connected to the resistance unit, the resistance unit may be connected to the amplifier, the amplifier may be connected to the diode unit, and the diode unit may be connected to the reset signal generator.

In an exemplary embodiment, the amplifier may include a resistor and an operational amplifier, an input terminal of the operational amplifier may be connected to the resistance unit, and an output terminal of the operational amplifier may be connected to the diode unit.

According to the exemplary embodiment of the invention, a display device may sense an overheating risk of a driver driving chip based on a sensing signal generated based on a power voltage.

### BRIEF DESCRIPTION OF THE DRAWINGS

The above and other features of the invention will become more apparent by describing in detail exemplary embodiments thereof with reference to the accompanying drawings, in which:

FIG. 1 is a block diagram showing an exemplary embodiment of a display device, according to the invention;

FIG. 2 is a plan view schematically illustrating an exemplary embodiment of a display device including a printed circuit board, according to the invention; and

FIG. 3 is a circuit diagram showing an exemplary embodiment of a sensing unit, according to the invention.

### DETAILED DESCRIPTION OF THE EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

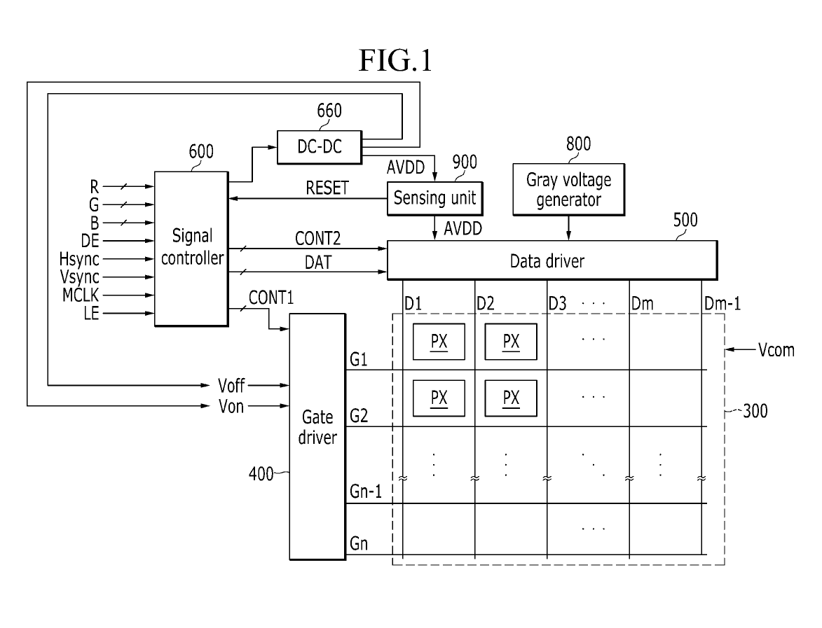

Hereinafter, an exemplary embodiment of a display device according to the invention will be described with reference to FIG. 1.

FIG. 1 is a block diagram illustrating an exemplary embodiment of a display device, according to the invention.

An exemplary embodiment of a display device includes a display panel 300 that displays an image, and a data driver 500 and a gate driver 400 that drive the display panel 300, as illustrated in FIG. 1. In such an embodiment, the display device further includes a signal controller 600 that controls the data driver 500 and the gate driver 400, a gray voltage generator 800 that generates and provides voltages to the gate and data drivers 400 and 500, a direct current-to-direct current (“DC-DC”) unit 660, a sensing unit 900, and an external power supply unit (not shown).

Hereinafter, the display panel 300 will be described in greater detail.

The display panel 300 includes a plurality of gate lines G1-Gn and a plurality of data lines D1-Dm, and the gate lines G1-Gn extend substantially in a horizontal direction, and the data lines D1-Dm extend substantially in a vertical direction while crossing the gate lines G1-Gn. Here, n and m are natural numbers.

The display panel 300 includes a plurality of pixels PX connected to the gate lines G1-Gn and the data lines D1-Dm. In an exemplary embodiment, the pixels PX may be arranged substantially in a matrix form. In such an embodiment, each pixel PX is connected to a corresponding gate line of the gate lines G1-Gn and a corresponding data line of the data lines D1-Dm, and each pixel includes a switching element (not shown) connected to the corresponding gate line and the corresponding data line. A control terminal of the switching element is connected to the corresponding gate line, an input terminal of the switching element is connected to the corresponding data line, and an output terminal of the switching element is connected to a pixel electrode. The pixel electrode defines one end of a liquid crystal capacitor in an exemplary embodiment where the display device is a liquid crystal display. In an exemplary embodiment, where the display device is an organic light emitting diode display, the pixel electrode, as one end of a light emitting diode, provides a control signal to a driving transistor that controls a current. In an alternative exemplary embodiment, where the display device is another type of display, the pixel electrodes thereof may perform different functions.

Hereinafter, an exemplary embodiment, where the display panel 300 includes a liquid crystal panel, but the invention is not limited thereto. In an alternative exemplary embodiment, the display panel 300 may be one of various display panels such as an organic light emitting panel, an electrophoretic display panel, a plasma display panel, and the like.

The signal controller 600 receives image data, e.g., red data R, green data G and blue data B, inputted from the outside, and control signals thereof, for example, a vertical synchronization signal Vsync, a horizontal synchronization signal Hsync, a main clock signal MCLK and a data enable signal DE, processes the image data and the control signals thereof based on an operation condition of the liquid crystal panel 300, and then generates and outputs the image data R, G and B, a gate control signal CONT1 and a data control signal CONT2.

The gate control signal CONT1 may include a scanning start signal (hereinafter, referred to as a ‘STV signal’) that instructs an output start of a gate-on pulse (a high period of a gate signal), and a gate clock signal (hereinafter, referred to as a ‘CPV signal’) that controls an output start of the gate-on pulse, for example.

The data control signal CONT2 includes a horizontal synchronization start signal that instructs input start of an image data DAT, and a load signal that instructs a corresponding data voltage to be applied to the data lines D1-Dm, for example.

The gate lines G1-Gn of the display panel 300 are connected to the gate driver 400, and the gate driver 400 alternately applies a gate-on voltage Von and a gate-off voltage Voff to the gate lines G1-Gn based on the gate control signal CONT1 applied from the signal controller 600. In an exemplary embodiment, as shown in FIG. 1, the gate driver 400 may receive the gate-on voltage Von and the gate-off voltage Voff output from the DC-DC unit 660. In an alternative exemplary embodiment, only one of the gate-on voltage Von and the gate-off voltage Voff is received from the DC-DC unit 660, and the other voltage may be generated from the gate driver 400.

The data lines D1-Dm of the display panel 300 are connected to the data driver 500, and the data driver 500 receives the data control signal CONT2 and the image data DAT from the signal controller 600. The data driver 500 converts the image data DAT into a data voltage using a gray voltage generated from the gray voltage generator 800 to transfer the converted image data DAT to the data lines D1-Dm.

The gray voltage generator 800 generates one set or two sets of a plurality of gray voltages corresponding to luminance of the pixel PX. In an exemplary embodiment, where the gray voltage generator 800 generates two sets, one set thereof has a positive value with respect to a common voltage Vcom, and the other set has a negative value with respect to the common voltage Vcom.

The gate driver 400 is connected to the gate lines G1-Gn of the display panel 300 to apply gate signals configured by a combination of the gate-on voltage Von and the gate-off voltage Voff from the outside to the gate lines G1-Gn. The gate driver 400 includes a plurality of stages, which is substantially linearly arranged as shift resistors.

The data driver 500 is connected to the data lines D1-Dm of the display panel 300 to select gray voltages from the gray voltage generator 800, and apply the selected gray voltages to the pixels PX as data voltages.

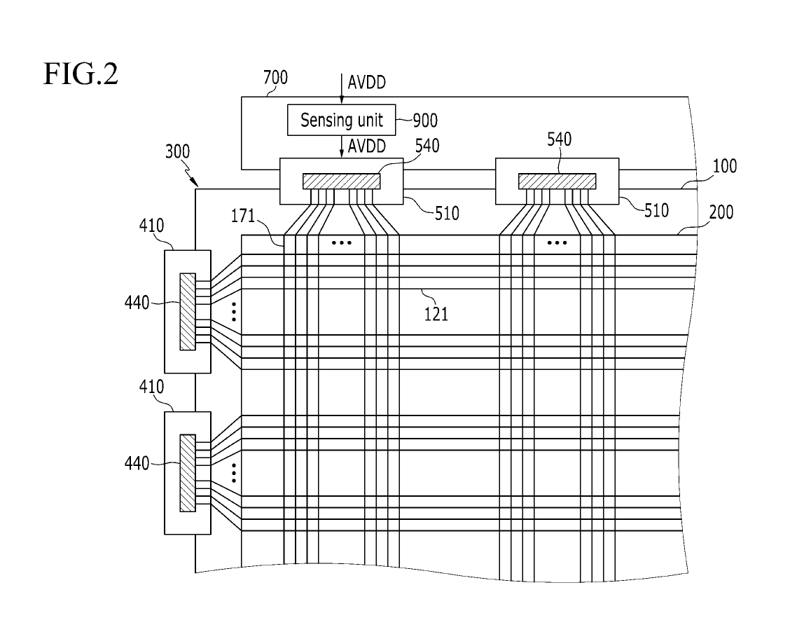

In an exemplary embodiment, each of the gate driver 400 and the data driver 500 may include a driving chip. According to an exemplary embodiment of the invention, as shown in FIG. 2, the gate driver 400 may include one or more gate driving chips, and the data driver 500 may include one or more data driving chips 540. In an exemplary embodiment of the invention, the data driving chip 540 and the gate driving chip 440 may be disposed, e.g., mounted, on the display panel 300 by a chip-on-glass (“COG”) method.

The signal controller 600 controls operations of the gate driver 400, the data driver 500 and the DC-DC unit 660.

According to an exemplary embodiment of the invention, the signal controller 600 may control an operation of the DC-DC unit in response to a reset signal RESET from the sensing unit 900. In such an embodiment, the signal controller 600 may control the DC-DC unit to stop the output of the power voltage when the reset signal RESET is in a low level, and the signal controller 600 may stop the operation in response to the reset signal RESET of the sensing unit 900. The signal controller 600 may stop the operation based on the reset signal in the low level.

Then, a displaying operation of the display device will be described in greater detail.

In such an embodiment, as described above, the signal controller 600 receives the image data R, G and B, and input control signals that controls displaying of the image data R, G and B, for example, the vertical synchronization signal Vsync, the horizontal synchronization signal Hsync, the main clock MCLK, the data enable signal DE, and the like, from an external graphic controller (not illustrated). The signal controller 600 generates the gate control signal CONT1, the data control signal CONT2, and the like based on the input control signals and the image data R, G and B, and processes the image data R, G and B based on an operational condition of the display panel 300, and then transmits the gate control signal CONT1 to the gate driver 400, and transmits the data control signal CONT2 and the processed image signal DAT to the data driver 500.

The gate control signal CONT1 includes a STV signal that instructs an output start of the gate-on voltage Von, a CPV signal that controls an output timing of the gate-on voltage Von, an output enable signal that limits a duration time of the gate-on voltage Von, and the like.

The data control signal CONT2 includes a horizontal synchronization start signal that instructs input start of the image data DAT, a load signal that instructs a corresponding data voltage to be applied to the data lines D1-Dm, and a data clock signal. According to an exemplary embodiment of the invention, the data control signal CONT2 may further include a reverse signal that reverts a polarity of the data voltage with respect to the common voltage Vcom (hereinafter, referred to as a “polarity of the data voltage”).

The data driver 500 sequentially receives image data DAT corresponding to pixels in a pixel row based on the data control signal CONT2 from the signal controller 600, and selects a gray voltage corresponding to each image data DAT among the gray voltages from the gray voltage generator 800 to convert the image data DAT into the corresponding data voltage and apply the converted data voltage to the data lines D1-Dm.

The gate driver 400 applies the gate-on voltage Von to the gate lines G1-Gn based on the gate control signal CONT1 from the signal controller 600 to turn on the switching elements Q connected to the gate lines G1-Gn. The data voltages supplied to the data lines D1-Dm are applied to the corresponding pixels PX through the turned-on switching elements Q.

When one horizontal period (“1H”), which is one period of the horizontal synchronizing signal Hsync, the data enable signal DE and the gate clock, elapses, the data driver 500 and the gate driver 400 repeat the operation described above with respect to pixels in a next pixel row. In such an embodiment, the data voltages are applied to all the pixels by sequentially applying the gate-on voltages Von to all the gate lines G1-Gn during one frame. In an exemplary embodiment, where the display device is a liquid crystal display as illustrated in FIG. 2, when one frame ends, the next frame starts, and a state of the inversion signal applied to the data driver 500 is controlled such that the polarity of the data voltage applied to each pixel is opposite to the polarity in the previous frame (e.g., frame inversion). In such an embodiment, a polarity of the data voltage flowing through one data line may be changed based on a characteristic of the inversion signal within one frame (e.g., row inversion, or dot inversion), and polarities of the data voltages applied to one pixel row may be different from each other (e.g., column inversion or dot inversion).

The DC-DC unit 660 receives the control signal of the signal controller 600 to convert external power generated from the external power supply unit by a DC-DC conversion and generate the power voltage AVDD, the common voltage Vcom, the gate-on voltage Von and the gate-off voltage Voff. The gate-on voltage Von and the gate-off voltage Voff are transferred to the gate driver 400, and the common voltage Vcom is transferred to the display panel 300.

The sensing unit 900 generates the reset signal RESET based on the power voltage AVDD. In an exemplary embodiment, the sensing unit 900 may be disposed on the circuit board 700. A process of generating the reset signal RESET by the sensing unit 900 will hereinafter be described in detail.

Hereinafter, an exemplary embodiment of the display device, according to the invention, will be described in detail with reference to FIG. 2.

FIG. 2 is a plan view schematically illustrating an exemplary embodiment of a display device including a printed circuit board, according to the invention.

Referring to FIG. 2, an exemplary embodiment of the display device includes a display panel 300, a data film 510, a gate film 410 and a circuit board 700.

In an exemplary embodiment, the display panel 300 includes a lower panel 100 and an upper panel 200, and the gate film 410 and the data film 510 may be disposed on or attached to the lower panel 100. In such an embodiment, the gate line 121 and the data line 171 may be disposed on or attached to the lower panel 100.

The data film 510 includes a wiring and a data driving chip 540, and the data film 510 may be attached to the lower panel 100 and extend substantially in a gate line direction. The display panel 300 is connected to the circuit board 700 through the data film 510. The wiring of the data film 510 transfers the signal of the printed circuit board 700 to the data driving chip 540 and transfers the signal of the data driving chip 540 to a data line 171 of the display panel 300.

The gate film 410 includes a wiring and a gate driving chip 440. The gate films 410 may be attached to the lower panel 100 and extend substantially in a data line direction.

The gate driving chip 440 and the data driving chip 540 transfer the respective voltages, that is, the gate voltage and the data voltage, respectively, to the gate line 121 and the data line 171 through a pan out unit of the lower panel 100 to display an image.

In an exemplary embodiment, the gate film 410 and the data film 510 may be attached to a flexible printed circuit (“FPC”) film.

The gate driver 400 includes the gate film 410 and the gate driving chip 440, and the data driver 500 includes a data film 510 and a data driving chip 540.

In an exemplary embodiment, as shown in FIG. 2, the gate driving chip 440 and the data driving chip 540 are disposed on the gate film 410 and the data film 510, respectively, but not being limited thereto. In an alternative exemplary embodiment, the gate driving chip 440 and the data driving chip 540 may be directly attached onto the lower panel 100 without the gate film 410 and the data film 510, or integrated onto the lower panel 100 by a same process as a thin film transistor attached to the display panel 300.

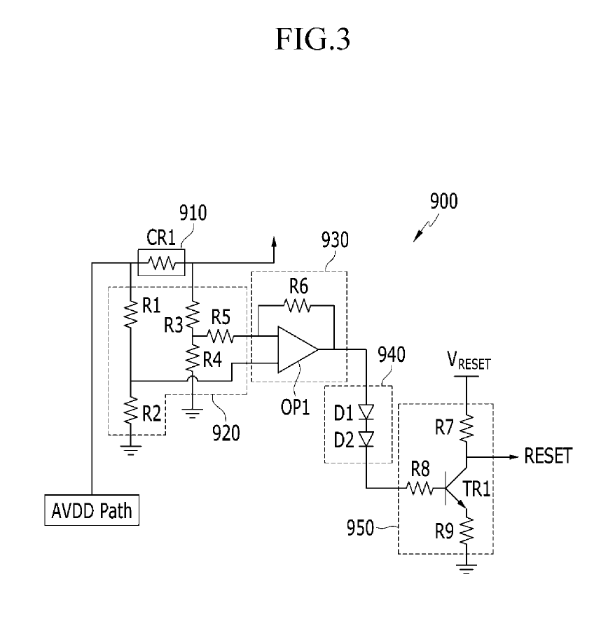

FIG. 3 is a circuit diagram of an exemplary embodiment of a sensing unit, according to the invention.

Referring to FIG. 3, an exemplary embodiment of the sensing unit 900 will be described in detail.

In an exemplary embodiment, the sensing unit 900 includes a measuring unit 910, a resistance unit 920, an amplifier 930, a diode unit 940 and a reset signal generator 950.

In an exemplary embodiment, the measuring unit 910 includes a resistor CR1. Further, the resistance unit 920 includes five resistors, e.g., a first resistor R1, a second resistor R2, a third resistor R3, a fourth resistor R4 and a fifth resistor R5.

One end of the resistor CR1 of the measuring unit 910 is connected to one end of the first resistor R1 in the resistance unit 920, and a power voltage is applied to one end of the resistor CR1 of the measuring unit 910. The other end of the resistor CR1 of the measuring unit 910 is connected to one end of the third resistor R3 in the resistance unit 920 and the data driving chip 540. According to an exemplary embodiment of the invention, a magnitude of the resistor CR1 of the measuring unit 910 may be in a range of about 0.1 ohm to about 0.2 ohm. The other end of the first resistor R1 is connected to one end of the resistor R2 in the resistance unit 920 and a first input of an operational amplifier OP1. The other end of the second resistor R2 is grounded. The other end of the third resistor R3 is connected to one end of the fifth resistor R5 in the resistance unit 920 and one end of the fourth resistor R4 in the resistance unit 920. In such an embodiment, the other end of the fourth resistor R4 is grounded. In such an embodiment, the other end of the fifth resistor R5 is connected to a second input of an operational amplifier OP1 of the amplifier 930.

In an exemplary embodiment, the amplifier 930 includes the operational amplifier OP1 and a resistor, e.g., a sixth resistor R6. One end of the sixth resistor R6 in the amplifier 920 is connected to the second input of the operational amplifier OP1, and the other end of the sixth resistor R6 is connected to an output of the operational amplifier OP1. The sixth resistor R6 may be a feedback resistor of the operational amplifier OP1.

In an exemplary embodiment, the diode unit 940 includes two diodes, e.g., a first diode D1 and a second diode D2. The output of the operational amplifier OP1 is connected to an anode of the first diode D1. The second diode D2 is serially connected to the first diode D1.

In an exemplary embodiment, the reset signal generator 950 includes a transistor TR1 and three resistors, e.g., a seventh resistor R7, an eighth resistor R8 and a ninth resistor R9. In an exemplary embodiment, the transistor TR1 of the reset signal generator 950 may be an NPN transistor. In such an embodiment, the reset signal generator 950 may generate the reset signal RESET in a high level or the reset signal RESET in a low level. In such an embodiment, the reset signal generator 950 receives a reset voltage V_{RESET}. In such an embodiment, the reset signal generator 950 generates the reset signal RESET based on the reset voltage V_{RESET} applied to the reset signal generator 950.

A cathode of the second diode D2 is connected to one end of the eighth resistor R8 in the reset signal generator 950. The other end of the eighth resistor R8 is connected to a base of the transistor TR1. The sixth resistor R6 in the reset signal generator 950 receives the reset voltage V_{RESET} from one end, and the other end of the resistor R7 in the reset signal generator 950 is connected to a collector of the transistor TR1.

One end of the ninth resistor R9 in the reset signal generator 950 is grounded, and the other end of the ninth resistor R9 is connected to an emitter of the transistor TR1.

In an exemplary embodiment, the measuring unit 910 senses an overheating sensing signal based on the power voltage. In such an embodiment, the overheating sensing signal may be a voltage drop value by the resistor CR1 of the measuring unit 910.

In an exemplary embodiment, the resistance unit 920 disperses a current flowing to the measuring unit 910. In such an embodiment, the resistance unit 920 effectively prevents the current from overflowing to the measuring unit 910. In such an embodiment, the resistance unit 920 provides input voltages, e.g., first and second input voltages, of the amplifier 930 to the amplifier 930.

In an exemplary embodiment, the amplifier 930 amplifies an input voltage thereto and outputs an output voltage to the diode unit 940. The input voltage of the amplifier 930 may be a difference between the first and second input voltages from the resistance unit 920. The amplifier 930 multiplies the input voltage by a gain to output the output voltage. In such an embodiment, the gain may be defined based on the sixth resistor R6. The amplifier 930 may also amplify the overheating sensing signal. The voltage drop value based on the resistor CR1 of the measuring unit 910 is amplified in proportion to the gain and output to the reset signal generator 950.

In an exemplary embodiment, the diode unit 940 provides a time constant value such that the transistor TR1 in the reset signal generator 950 may be turned on or opened at a predetermined value. In such an embodiment, when the voltage drop value in the resistor CR1 of the measuring unit 910 has a value which is greater than the predetermined value, the diodes D1 and D2 of the diode unit 940 allow the transistor TR1 to be turned on or open. In an alternative exemplary embodiment of the invention, the diode unit 940 may be omitted. In one exemplary embodiment, where the transistor TR1 is turned on when the voltage drop value in the resistor CR1 of the measuring unit 910 has a value which is greater than the predetermined value by another unit, the diode unit 940 may be omitted in the sensing unit 900. In an exemplary embodiment, the number of diodes including the diode unit 940 may be determined based on the predetermined value for the voltage drop value in the resistor CR1 of the measuring unit 910. According to one exemplary embodiment of the invention, for example, the predetermined value for the voltage drop value in the resistor CR1 of the measuring unit 910 may be about 0.01 volt (V).

The reset signal generator 950 outputs the reset signal RESET in a low level to the signal controller 600 based on the overheating sensing signal sensed in the measuring unit 910. According to an exemplary embodiment of the invention, when the voltage drop value in the resistor CR1 of the measuring unit 910 is greater than the predetermined value, the reset signal generator 950 does not output the reset signal in the high level, but outputs the reset signal in the low level. According to an exemplary embodiment of the invention, as described above, the predetermined value for the voltage drop value in the resistor CR1 of the measuring unit 910 may be about 0.01 V.

Next, an operation of an exemplary embodiment of the sensing unit 900, where the predetermined value for the voltage drop value in the resistor CR1 of the measuring unit 910 is about 0.01 V, will be described.

In an exemplary embodiment, where the display device has a frequency of about 60 Hz and a size of about 46 inches, the data driving chip 540 generally consumes a current in a range of about 35 milliamps (mA) to about 100 mA. In such an embodiment, the voltage drop value in the resistor CR1 of the measuring unit 910 may have a value in a range of about 0.0035 V to about 0.01 V. In such an embodiment, values of the remaining elements, e.g., the first to ninth resistors R1 to R 9, and the first and second diodes D1 and D2, may be pre-set.

In an exemplary embodiment, where the resistance of the resistor CR1 of the measuring unit 910 is about 0.1 ohm, and the transistor TR1 is turned on only when the voltage drop value in the resistor CR1 is greater than 0.01, the values of the remaining elements may be pre-set as below.

In such an embodiment, the D1 and D2 may be omitted. In such an embodiment, the resistance of the first resistor R1 may be about 1 kilohm, the resistance of the second resistor R2 may be 1 about kilohm, the resistance of the third resistor R3 may be 1 about kilohm, the resistance of the fourth resistor R4 may be 1 about kilohm, the resistance of the fifth resistor R5 may be 1 about kilohm, the resistance of the sixth resistor R6 may be about 100 kilohm, the resistance of the seventh resistor R7 may be about 4.7 kilohm, the resistance of the eighth resistor R8 may be about 47 kilohm, and the resistance of the ninth resistor R9 may be about 1 kilohm.

In such an embodiment, when the voltage drop value in the resistor CR1 of the measuring unit 910 is about 0.01 V, the transistor TR1 does not open or is turned off. Accordingly, the reset signal generator 950 outputs the reset signal in the high level to the signal controller 600.

In such an embodiment, when the voltage drop value in the resistor CR1 of the measuring unit 910 is about 0.03 V, the transistor TR1 is turned on. Accordingly, in such an embodiment, where the reset voltage V_{RESET} applied to the reset signal generator 950 is grounded, the reset signal generator 950 outputs the reset signal in the low level to the signal controller 600.

Herein, the voltage drop value generated in the resistor CR1 of the measuring unit 910 is high means that a value of the current flowing in the resistor CR1 is high. When the overcurrent flows in the resistor CR1 of the measuring unit 910, the current having a high value flows into the data driving chip 540. Accordingly, the overheating due to the overcurrent may occur in the data driving chip 540.

In exemplary embodiment described herein, the sensing unit 900 measures the voltage drop value in the resistor CR1 of the measuring unit 910, and outputs the reset signal RESET in the low level to the signal controller 600 in the case where there are concerns of overheating. In such embodiments, the signal controller 600 may stop the operation when the reset signal in the low level is received.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a display panel comprising a gate line, a data line, and a pixel connected to the gate line and the data line;
a data driver connected to the data line;
a gate driver connected to the gate line;
a direct current-to-direct current unit which transfers a gate-on voltage or a gate-off voltage to the gate driver;
a signal controller which controls the data driver, the gate driver and the direct current-to-direct current unit; and
a sensing unit,
wherein
the direct current-to-direct current unit generates a power voltage based on a control signal of the signal controller, and
the sensing unit comprises
a measuring unit which senses a sensing signal based on a power voltage signal applied to the data driver; and
a reset signal generator which generates a reset signal based on the sensing signal.

2. The display device of claim 1, wherein
the sensing unit further comprises a resistor, and
the sensing signal has a value corresponding to a voltage drop value in the resistor of the sensing unit based on the power voltage.

3. The display device of claim 2, wherein
when the value of the sensing signal is equal to or less than a predetermined value, the reset signal generator outputs the reset signal in a high level based on a reset voltage applied thereto.

4. The display device of claim 3, wherein
the reset signal generator comprises a transistor.

5. The display device of claim 4, wherein
when the value of the sensing signal is greater than the predetermined value, the reset signal generator outputs the reset signal in a low level by the transistor which is turned on by the sensing signal and thereby connects the reset voltage to a ground.

6. The display device of claim 5, wherein
the predetermined value is about 0.01 volt.

7. The display device of claim 6, wherein the sensing unit further comprises:
an amplifier which amplifies the sensing signal.

8. The display device of claim 7, wherein the sensing unit further comprises:
a resistance unit which distributes a current flowing in the resistor of the sensing unit to flow in the amplifier.

9. The display device of claim 8, wherein the sensing unit further comprises:
a diode unit which receives an output signal from the amplifier and outputs a signal, which turns on the transistor when the value of the sensing signal is greater than about 0.01 volt, to the transistor.

10. The display device of claim 9, wherein
the diode unit comprises two diodes connected to each other in series.

11. The display device of claim 9, wherein
the measuring unit is connected to the resistance unit,
the resistance unit is connected to the amplifier,
the amplifier is connected to the diode unit, and
the diode unit is connected to the reset signal generator.

12. The display device of claim 9, wherein
the amplifier comprises a resistor and an operational amplifier,
an input terminal of the operational amplifier is connected to the resistance unit, and
an output terminal of the operational amplifier is connected to the diode unit.

13. The display device of claim 5, wherein
the signal controller stops the operation when the signal controller receives the reset signal in the low level from the sensing unit.

14. The display device of claim 5, wherein
the signal controller controls the direct current-to-direct current unit to control a generation of the power voltage when the signal controller receives the reset signal in the low level.

15. The display device of claim 4, wherein
the transistor of the reset signal generator is an NPN transistor.
